(19) United States
(12) Patent Application Publication
(10) Pub. No.: US 2018/0288005 A1
(43) Pub. Date: Oct. 4, 2018

(54) PROTEIN BASED CRYPTOGRAPHY FOR INDIVIDUALIZED NETWORK ENCRYPTION SERVICES

(71) Applicant: Carlos Enrique Brathwaite, Brooklyn, NY (US)

(72) Inventor: Carlos Enrique Brathwaite, Brooklyn, NY (US)

(21) Appl. No.: 16/001,008

(22) Filed: Jun. 6, 2018

Related U.S. Application Data
(63) Continuation-in-part of application No. 15/350,422, filed on Nov. 14, 2016.

(51) Int. Cl. H04L 29/06; G06F 19/16; H04L 9/32; H04L 9/06

(52) U.S. Cl. CPC H04L 63/0272; G06F 19/16; H04L 2209/04; H04L 9/0618; H04L 9/3247

(57) ABSTRACT

This invention is directed to a method of providing extra levels of encryption to a message by imposing a mask on top of an already encrypted message, wherein the mask sits on top of a protein folding of a sequence of amino acids.

### CROSS-REFERENCE TO RELATED APPLICATIONS

This application is a continuation-in-part of pending U.S. Nonprovisional application Ser. No. 15/350,422, filed Nov. 14, 2016, the disclosure of which is incorporated herein by reference.

### FIELD OF INVENTION

This invention is directed to a method of providing extra levels of encryption to a message by imposing a mask on top of an already encrypted message, wherein the mask is incorporated into a protein folding of a sequence of amino acids.

### BACKGROUND OF INVENTION

For thousands of years, people have tried to communicate with others in secret. Often, this was done by sending messages in a coded form. The code essentially replaces a word or letter or number with a different word or letter or number. Thus, the code uses a substitute to symbolize words, letters, or numbers. The code always uses the same substitute to symbolize the same words, letters, or numbers.

By encoding a message according to a particular code, it can be read only by someone that has the correct codebook that indicates what each new word or letter or number represents or symbolizes. In some cases, the only people with the code and codebook are the sender and the intended recipient. The code will provide the sender a way to change the message into a form that cannot be easily read and the codebook will provide the intended recipient with a way to change the message back into a form that can be easily read. Unfortunately, many codes have become known. Thus, it has become necessary to find better ways of disguising messages.

Ciphers provide a better means for disguising messages. A cipher is a method of changing plain text into a different form so that it cannot be read as plain text. Ciphers are algorithms or instructions for changing a small part of the message to something else called a cipher text. In this way, the message is encrypted before it is sent and then, once it is received, the message is decrypted by the recipient. In particular, the sender will write a message in plain text and then convert the message into cipher text using a cipher. After the recipient receives the cipher text message, the recipient will decrypt the cipher text message using a decipherer. The cipher text will be converted back into plain text, thereby allowing the recipient to be able to read the message as sent by the sender.

### Cryptography

The art and science of writing and solving ciphers is called cryptography. In particular, cryptography involves encrypting and decrypting messages. Encryption is the process of turning a plain text message into a cipher text message. Decryption is the process of turning a cipher text message into a plain text message.

More recently, cryptography includes authentication, digital signatures, et cetera. This is done by using difficult mathematical problems as the basis for cryptographic techniques.

Another recent addition to cryptography involves the use of DNA. A plain text message is converted from ASCII into a DNA sequence cipher text message by way of an algorithm. The DNA sequence cipher text is converted back to an ASCII plain text message by way of an encryption/decryption key. Initially, three DNA bases were used to represent a single alphanumeric character. Because DNA has 4 bases (A, T, C, G), a maximum of 64 (4×4×4) ASCII characters can be formed. In order to represent the 256 extended ASCII characters, more DNA base pairs can be used to represent a single alphanumeric character.

The advantage of DNA encryption is that it provides a difficult mathematical problem that makes it less likely that an attack on the message or data will be successful. DNA encryption can be made stronger by adding a mask to the cipher text. This can be done by way of a masking value generator, wherein the masking value is combined with the encrypted cipher text. In some cases, more than one mask can be combined with the encrypted cipher text. By doing this, the encrypted cipher text combined with one or more masks increases the mathematical difficulty involved with a brute force attack. As the mathematical difficulty of decrypting a masked cipher text is increased, the more resistant to a brute force attack the method of encryption will be.

Thus, it would be beneficial to identify one of the most difficult mathematical problems and use that problem as the basis for cryptographic techniques.

### SUMMARY OF THE INVENTION

Accordingly, it is the subject of this invention to use protein based cryptography to provide an additional layer of cryptography to prevent possible leakage of a message or data. In particular, using protein folding for the mask of a cipher text provides a very difficult mathematical problem and thus provides a lot of resistance from a brute force attack.

Thus, a method of this invention provides an extra level of encryption to a message or data by imposing a mask on top of an already encrypted message, wherein the mask is a protein folding of an amino acid sequence.

Protein based cryptography is based on one of the most difficult mathematical problems in physical chemistry today, which is protein folding. A method of the present disclosure uses the mathematical complexity of protein folding and the obscurity of synthetic amino acids to encrypt data. Additionally, a method of the present disclosure provides intermediate data protection by application of a new amino acid mask.

The “protein folding problem” consists of three closely related puzzles: (a) What is the folding code?; (b) What is the folding mechanism?; and (c) Can we predict the native structure of a protein from its amino acid sequence?

The complexity of synthetic amino acids continues to grow as new amino acids are created in labs every day. Currently, there are over 110,000 synthetic amino acids. This makes it very difficult to guess the folding of new amino acids sequences. By using this complexity as the basis for a folded protein based on a randomly generated amino acid sequence, wherein the amino acids can be natural, synthetic, or a combination of natural and synthetic, the folded protein serves to increases the work factor to decode to around 10¹⁰⁰. If a hacker tries to decode the protein fold at the rate of 100 billion a second, it would take longer than the age of the universe to find the correct protein fold.

Protein based cryptography is based on the protein folding of amino acid sequences. There are 22 naturally occurring amino acids, 20 of which genetically code. These 20 amino acids can be used in protein based cryptography.

Although only 20 amino acids are genetically coded, over 100 have been found in nature. Some of these have been detected in meteorites, especially in a type of meteorites known as carbonaceous chondrites. Microorganisms and plants often produce very uncommon amino acids, which can be found in peptidic antibiotics.

More recently, with the advent of synthetic biology many new amino acids have been synthetically created, thereby adding to the pool of amino acids that may be used in cryptography.

Non-natural amino acids are non-proteinogenic amino acids that either occur naturally or are chemically synthesized. Whether utilized as building blocks, conformational constraints, molecular scaffolds or pharmacologically active products, non-natural amino acids represent a nearly infinite array of diverse structural elements for the development of new leads in peptidic and non-peptidic compounds. Due to their seemingly unlimited structural diversity and functional versatility, they are widely used as chiral building blocks and molecular scaffolds in constructing combinatorial libraries. Non-natural amino acids can be found at: libraries.http://www.sigmaaldrich.com/chemistry/chemistry-products.html?TablePage=16274965

Protein folding is the physical process by which a protein chain acquires its native three-dimensional structure. When a protein is mis-folded, the mis-folded protein causes diseases like amyloidosis, Alzheimer's disease, Huntington's disease, and Parkinson's disease. Medical research is looking into how and why proteins get mis-folded.

The protein folding structure is called a conformation assembly and it includes four configurations. Each of these four configurations must be correct in order for the conformation assembly to be correct, thereby ensuring that the protein formed is folded correctly. The first is called the primary structure, which is the linear structure of the peptide bonds. The second is called the secondary structure, which covers the backbone interactions, hydrogen bonds, alpha helix, and beta sheets. The third is called the tertiary structure, which covers high order of folding and distant interactions. The fourth is called quaternary structure, which covers bonding with polypeptides. See, e.g., http://people.math.sc.edu/dix/fold.pdf

A protein based cryptography protocol uses the folded protein's conformation assembly. For proper conformation assembly, all four structures must be correct. Each structure provides information for a proper conformation. For protein based cryptography, we can use the four structures as cryptography keys that can be used with an additional variable. Temperature can act as a secret variable to the cipher. This is the case because temperature affects the folding of protein. In particular, the primary, secondary, tertiary, and quaternary structures are all dependent on the temperature. A protein will fold differently depending on the temperature at which the protein is folded.

The protein based cryptography protocol inputs include: the primary structure having a linear structure with x coordinates; the secondary structure having a two-dimensional structure with x and y coordinates; the tertiary structure having a three-dimensional structure with x, y, and z coordinates; the quaternary structure having a three-dimensional structure with x, y, and z coordinates; and the temperature that the protein was folded at in Celsius degrees.

In one embodiment of the present invention, a protein mask will cover a newly encrypted message. The protein is composed of amino acids that are randomly generated to disguise the encoded message. The protein mask provides further protection against leakage of the encoded message by being folded.

Everyday cryptography algorithms are being stress tested and broken by hackers, and criminal groups. It is a constant battle to stay ahead of these groups. This method addresses this problem by adding another level of protection in the arsenal of defense. This method provides a difficult algorithm and transforms the numbers to a DNA sequence adding to the hacker's confusion in trying to break the encryption. The hacker must have an understanding of both cryptography techniques and biotechnology to have any hope of breaking this system.

The method of the present disclosure also preferably provides an electronic signature comprised of a randomly generated amino acid sequence, wherein the amino acids may be naturally occurring or synthetic and will create a unique signature to ensure non-repudiation.

A method of encrypting includes the steps of:

converting a plain text message into a DNA sequence cipher text message;

using an amino acid generator to generate a random amino acid sequence to create an electronic signature comprised of amino acids (natural and synthetic), wherein the amino acid sequence electronic signature will be merged with the DNA sequence cipher text message.

using an amino acid generator to generate a random amino acid sequence to create a data mask equal to the size of the DNA sequence cipher text and amino acid sequence electronic signature;

superimposing the amino acid sequence data mask onto the DNA sequence cipher text message and amino acid sequence electronic signature to prevent data leakage, thereby creating a masked marker that encodes onto a primary protein structure of an amino acid sequence;

using a temperature generator to generate a random temperature that will be passed to the primary structure generator and sending that temperature value to the user for decryption;

creating a primary protein structure using N number of amino acids generators to generate randomly N number of amino acid sequences based on the temperature value sent from the temperature generator, wherein the number of amino acids of a primary protein structure will equal to the number of amino acids of the amino acid sequence data mask;

merging the amino acid sequence data mask (which includes the DNA sequence cipher text and amino acids electronic signature) and masked marker onto an amino acid sequence foundation primary structure, wherein the amino acid sequence foundation is a protein; and

folding of the primary structure into secondary, tertiary, and quaternary structures at a given specific temperature based on the random values generator.

At this point, the message is encrypted. It can be sent on the internet to another user for decryption using the proper software or for storage in a database in a local system to prevent unauthorized use of data.

A method of decrypting includes the steps of:

inputing into the program all 5 inputs: primary x value, secondary x and y values, tertiary x, y, and z values, and quaternary x, y and z values, and temperature in degrees in C.

If the values are correct the system will unfold the folded protein and remove the mask using the masked marker. The system will convert the message from DNA sequence cipher text message into an ASCII plain text message. The message can be verified by checking the amino acid sequence base electronic signature to ensure non-repudiation. If the values are incorrect the system will not unfold the message until all of the values are correct.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Although the present invention is described with regard to a “computer” on a “computer network”, it should be noted that optionally any device featuring a data processor and the ability to execute one or more instructions may be described as a computer, including but not limited to any type of personal computer (PC), a server, a cellular telephone, an IP telephone, a smart phone, a PDA (personal digital assistant), or a pager. Any two or more of such devices in communication with each other may optionally comprise a “computer network”.

### BRIEF DESCRIPTION OF THE DRAWINGS

FIG. 1 is a flow chart depicting the steps of encrypting and masking a message.

FIG. 2 is a flow chart depicting the steps of unmasking and decrypting a message.

### DETAILED DESCRIPTION OF THE INVENTION

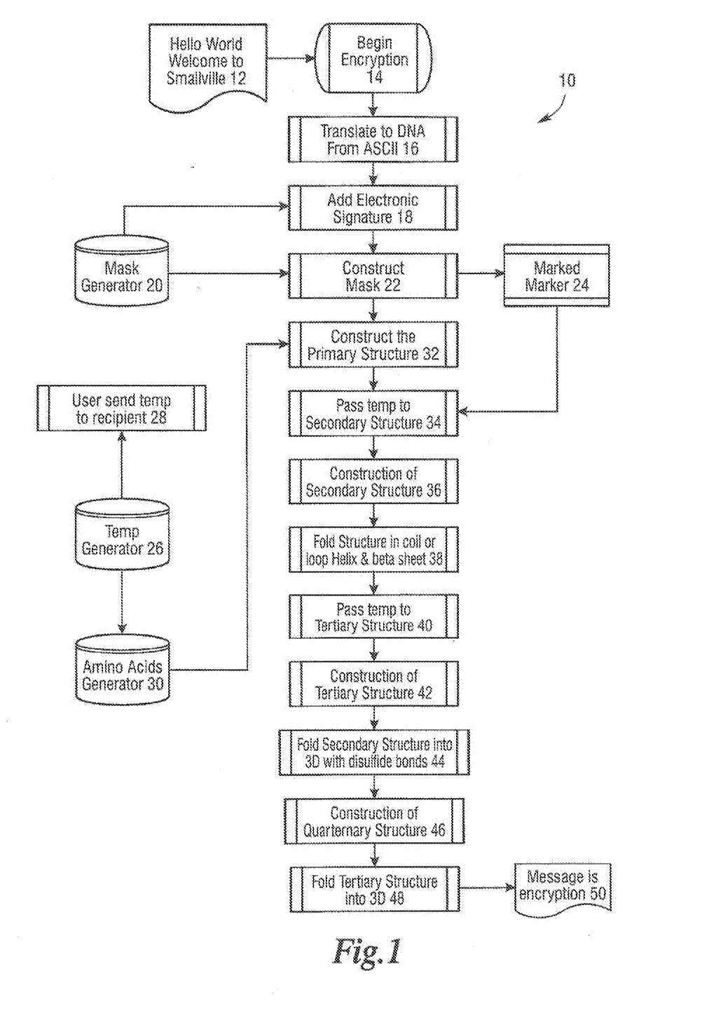

FIG. 1. depicts a method of encrypting a message 10 including the steps of: composing a plain text message 12; beginning encryption 14; converting the plain text message to a cipher text message by translating the plain text message from ASCII to DNA 16; adding an electronic signature to the cipher text message 18, wherein the electronic signature is created by random mask generator 20; constructing a mask to superimpose onto the cipher text message, wherein the mask is also created by a random mask generator 20; superimposing the mask onto the cipher text message, thereby creating a masked marker 24; obtaining a temperature from temperature generator 26; sending the recipient of the message the temperature generated by the temperature generator 28; obtaining a sequence of amino acids from amino acid generator 30; passing the temperature and the amino acid sequence to the masked marker and constructing the primary structure of the amino acid sequence, thereby creating a linear protein structure 32; passing the temperature to a secondary structure 34; constructing a secondary structure from the linear protein structure 36, wherein the secondary structure is folded into a coil or loop helix and beta sheet and is two dimensional 38; passing the temperature to a tertiary structure 40; constructing the tertiary structure from the secondary structure 42, wherein the tertiary structure is made from disulfide bonds and is three dimensional 44; constructing a quaternary structure from the tertiary structure 46, wherein the quaternary structure further folds the tertiary structure into a three dimensional structure 48; and obtaining a masked and encrypted message 50.

For visualization purposes, one can think of the process, by way of analogy only, as writing a message on a sheet of paper, scribbling over the message, placing a sheet of paper over the scribbled out message, then folding the sheet of paper into two dimensional, three dimensional, and further three dimensional structures, thereby completely covering the message. The folding of the paper can be thought of as being similar to Oragami, wherein there is a set of specific folds to form a two dimensional, three dimensional, and further three dimensional structure.

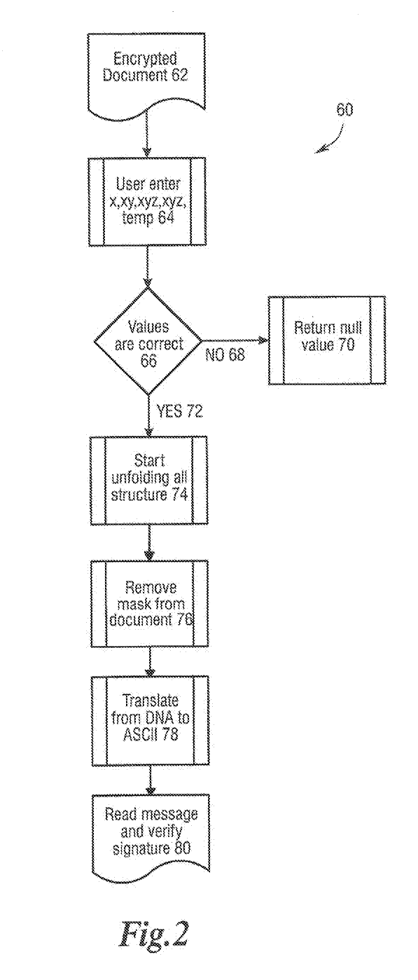

FIG. 2. depicts a method of decrypting a masked and encrypted message 60 including the steps of: receiving a masked and encrypted message or document 62; having previously received the input values, a system will verify whether the input values 64 are correct 66; if the system verifies that the input values are not correct 68, then the system will return a null value to the user 70; if the system verifies that the input values are correct 72, then the system will begin unfolding the quaternary protein structure 74, thereby removing the mask from the cipher text message 76; translating the cipher text message from DNA to ASCII 78, thereby revealing a plain text message; and verifying the electronic signature 80 prior to reading the message.

In another embodiment, this disclosure pertains to a method of using protein folding cryptography to provide an additional layer of cryptography to prevent possible leakage of a message by imposing a mask on top of an already encoded or encrypted message, wherein the mask is a protein folding of amino acids.

In one embodiment, the method of protein folding cryptography, may be built in a lab or may be a simulation in a computer security program.

In a preferred embodiment, the method of protein folding cryptography will be implemented by way of a computer security program. The steps will be simulated in a computer. The steps of a method of encryption include:

translating a plain text message from ASCII to a DNA sequence (this step is well known to those having ordinary skill in the art and thus will not be further described);

adding an electronic signature;

constructing a mask;

generating a random temperature;

constructing a protein by randomly generating a sequence of amino acids;

creating the primary protein folding structure;

creating the secondary protein folding structure;

creating the tertiary protein folding structure; and

creating the quaternary protein folding structure.

In a preferred embodiment, the electronic signature is a sequence of naturally occurring and/or synthetic amino acids for demonstrating the authenticity of a digital message or document. A valid electronic signature gives a recipient reason to believe that the message was created by a known sender, that the sender cannot deny having sent the message (authentication and non-repudiation), and that the message was not altered in transit (integrity).

In another embodiment, data masking is the process of providing a safeguard to original data without transforming it to intermediate data. In particular, data masking provides obscured data to the user and this data sent is called masked data. In masking methodology, it is not necessary to reconstruct original data from any intermediate data. This is the most fundamental difference between encryption and masking. In encryption, the original data is transformed into encrypted data and original data is retrieved from it. In contrast, in masking no transformation of the original data is necessary, rather the original data is directly protected. The most significant property of masking is that masking methodology is not reversible. The strength of masking methodology lies in the fact that masking should be done in such a way that there should not be any way to retrieve original data from masked data.

In another embodiment, a mask generator is a database inside of the computer system program that contains a listing of approximately 110,020 naturally occurring and synthetic amino acids that will be used to construct the mask. The mask generator will randomly select amino acids to safeguard the original data (also called a plain text message or original message) into intermediate data. This mask will be superimposed onto the original data. The system will give the mask a value. The mask value will be passed to the primary structure and will be encoded into that structure. At the time of decryption, the mask value will be used to remove the intermediate data, thereby leaving only the original data.

In another embodiment, the primary protein folding structure is based on the temperature selected. Protein folding behavior is dictated by temperature. The computer security program will access the temperature generator, which will select or generate a random temperature in Celsius.

Once a temperature has been selected, the temperature will be passed to the user and amino acid generator. The amino acid generator could be the same generator as the mask generator or a different one.

The amino acid generator will begin construction of the primary structure of the protein based on the temperature that was passed to it. The program will simulate building long chain, multiple amino acids that are linked together by peptide bonds. Peptide bonds are formed by a biochemical reaction that extracts a water molecule as it joins the amino group of one amino acid to the carboxyl group of a neighboring amino acid.

The user will pass the temperature to a recipient in an outband communication method, as part of a two-factor authentication.

After the primary protein structure has been completed, the mask (that is covering the original data) will be superimposed on to the primary protein structure. The primary structure is a linear structure of peptide bonds with x coordinates values. Along with the mask value that is required to decipher the masked message, the temperature will be passed onto the computer program to determine the secondary structure of the protein.

After receiving the temperature, the computer program will start forming the secondary structure, which includes the backbone interaction, hydrogen bonds, alpha helix and beta sheets of the protein. Forming a secondary structure with two-dimensions provides x and y coordinates with coils, loop helices, and beta sheets.

After receiving the temperature, the computer program will start folding the tertiary structure of the protein, which has a three-dimensional structure having x, y, and z coordinates. The tertiary structure with three-dimensions will have distant interactions with disulfide bonds.

After receiving the temperature, the computer program will start folding the protein into a quaternary structure, which is a three-dimensional structure having x, y, z coordinates.

After the quaternary structure of the protein is created, the message is masked and encrypted.

A method of decrypting includes the steps of:

receiving the temperature value by way of outband communication;

entering the temperature, x, (x, y), (x, y, z), and (x, y, z) values;

checking the entered values with known values of the folded protein;

unfolding the message and removing the mask based on the mask values; and verifying the amino acid sequence electronic signature; and

translating the DNA cipher text message to ACSII plain text message.

If the values are correct, the protein will unfold, but if the values are incorrect the protein will not unfold.

### Individualized Network Encryption Services

The above method can also be used and expanded upon to provide additional encryption for users of digital records. A major problem that many individuals may experience while using digital records on a device is from side-channel attacks.

One approach to protecting an individual's device from a side-channel attacks and from other attacks is to use an individualized network encryption service that incorporates protein-based cryptography. The individualized network encryption service incorporating protein-based cryptography provides very thorough data encryption for digital records, which are at high risk of being hacked.

### Digital Records

A digital record is anything that can be viewed on a computer screen, such as a desktop, laptop, tablet, or mobile phone. A digital record may be created from a paper record or may be a record that was created digitally. Many digital records contain high-value or confidential data. Examples include, but are not limited to, birth and death certificates, marriage licenses, deeds and titles of ownership, rights to intellectual property, educational degrees, financial accounts, medical history or medical records, insurance claims, citizenship and voting privileges, voting ballots, location of portable assets, provenance of food and diamonds, job recommendations and performance ratings, charitable donations tied to specific outcomes, employment contracts, material decision rights, and virtual anything else that can be expressed in code.

Moreover, any financial record can be recorded as a digital record. Most notably, all cryptocurrency exchanges are recorded digitally.

### Cryptocurrency

A cryptocurrency is digital or virtual currency that uses cryptography for security. In the case of cryptocurrencies, there is no central bank. Rather, the transactions are recorded in a block. A series of blocks is called a blockchain. The blockchain utilizes various encryption techniques that regulate the generation of units of currency and verify the transfer of funds. Cryptocurrency is one of many possible applications that utilize the blockchain for recording transactions and tracking cryptocurrency.

### Blockchain

A blockchain is essentially an electronic running ledger or list of digital records. In the case of blockchain, the digital records are called called blocks. As each block is added, the blockchain continuously grows. Each block is linked and secured or protected by using cryptography. Typically, each block contains a cryptographic hash of the previous block, thereby creating a blockchain. The cryptographic hash of the previous block includes a timestamp of when the block was created and transaction data. Blockchain technology or distributed ledger technology is present everywhere and its use is expected to grow.

By design, a blockchain is inherently resistant to modification of the data. This is because the blocks are chained together and each subsequent block contains information from the previous block. So changing one block changes the data in all subsequent blocks. If someone tries to change the content of a block without authorization to do so, everyone that monitors the blockchain will see the attempted change and the activity will be flagged as suspicious.

The data or information within a public blockchain is visible to the public, while the data or information within a private blockchain is not visible to the public.

Because the data or information that is being recorded to a block is highly sensitive or confidential, it is desirable to keep the information as secure as possible.

### Cryptowallet or Cryptostorage

Every time that a person wants to buy or sell cryptocurrency or wants to record a digital record, a block is created to record the transaction. The transaction is recorded to the specific block that handles the transaction. In most cases, the person will use some sort of device to buy or sell cryptocurrencies or to create the digital record. As can be imagined, any person that wants to buy or send cryptocurrency or create a digital record essentially has an abstract cryptowallet or an abstract cryptostorage. While blockchain is relatively secure and encrypted and at a relatively low risk of attack, the application that uses the blockchain are not. When a person's individual device is involved, the transaction is at risk for side-channel attacks. In some cases, an attacker may add a trojan horse program to cryptostorage that was bought over the internet, especially if they know the crypto storage was for purposes of storing digital currency.

### Side-Channel Attack

A side-channel attack is any attack based on information gained from the physical implementation of a device or computer system. That is, the weakness or leak is from the physical device, rather than any weakness or leak from the algorithm.

Examples of information that a device or computer system may leak include timing information, power consumption, electromagnetic leaks, and sound leaks. This information can be used during a side-channel attack to break the system.

In the world of cryptocurrency or creation of a digital record, the side-channel leak may relay information that a blockchain is being created, meaning that a transfer of cryptocurrency or creation of a digital record is taking place.

As such, device users need ways to prevent or avoid side-channel attacks. One method is the use of individualized network encryption services that provide a means for users to encrypt the digital record as soon as the digital record becomes located on that user's individualized device.

### Individualized Network Encryption Services

A method of individualized network encryption services is disclosed. Typically, a user will initiate the creation of a digital record by way of a computer, laptop, tablet, phone, or other device. The digital record is created by a service or product provider of digital records. As discussed above, the digital record may contain any type of valuable data such as medical records, financial transactions, or purchases or sales of cryptocurrency.

After the user initiates the creation of data or a digital record, the service provider will send the data or digital record back to the user's device. It is at this point that the data or digital record needs to be encrypted. All processing such as encrypting and decrypting of the digital record is performed as part of the individualized network encryption services.

In one embodiment, a method of encrypting a digital record includes the steps of:

uploading a digital record to a system capable of encrypting data, wherein the uploading is done by way of a secure VPN tunnel;

scanning the digital record for viruses;

converting the digital record to a DNA sequence cipher text message by way of a random DNA sequence generator;

scanning the DNA cipher text message for viruses;

generating a protein base signature by way of a random amino acid generator;

superimposing a mask on the newly encrypted message; and

obtaining a masked and encrypted digital record.

In a preferred embodiment the user accesses the individualized network encryption services (INES) system by way of a secured connection such as hypertext transfer protocol secure (HTTPS) or transport layer security (TLS) or secured sockets layer (SSL) to gain access to the service.

The system will prompt the user to register with his or her credentials. The system will verify the user and payment details. As described below, the user will have several service options available to encrypt his or her data on the system. Preferably, the users will have several options for their method of encryption. These options include standard encryption services, safe deposit or split key encryption services, or full encryption services.

Once the user has logged in, the system will establish a virtual private network (VPN) tunnel between the user's device and the system.

The user will select which digital record they want to encrypt.

The system will scan the digital file for malware or ransomware with standard malware or ransom software, which is well known in the art and thus will not be described in further detail here.

If no malware or ransomware is detected, then the system will run another scan with an amino acids translation adapter that encodes malware or ransomware in amino acids form. This step protects the system from a target attack in synthesized amino acids malware. Security researchers have been known to encode malware and ransomware in amino acid and DNA coding, thus it is important to ensure that there is no secondary malware or ransomware in the digital record. If no malware or ransomware is detected, the system will proceed to the next steps. If the digital record has any malware or ransomware, the session will be terminated.

The system will perform encryption by way of protein-based cryptography.

In order to decrypt the digital record, the system will prompt the user to verify the password keys are working with the secret key. Once the user is satisfied, then the data on the digital record can be decrypted.

### Configurations of Individualized Network Encryption Services

In one embodiment, the INES is configured as a cloud computing encryption service that can be incorporated in private blockchain services or utilized by public blockchains.

In another embodiment, the INES is configured as a cloud computing encryption service for individual users or other cloud providers.

In yet another embodiment, the INES is configured as a standalone enterprise version that can be sold to customers with their own rules of biophysics and thermochemistry of any amino acids thus making each system unique.

If the user selects the standard encryption services, the system will erase all the data associated with the digital record when the session ends. Any time the user needs to decrypt the digital record they need to establish a VPN to the INES system. The INES system will prompt the user to upload their digital record to the INES system and will prompt the user to enter the password keys and secret key. After the digital record is decrypted, the INES system will upload the decrypted digital record back onto the user's device. The INES system will erase all of the data from that session. If necessary, the digital record can be re-encrypted again.

If the user selects the safe deposit encryption service (split keys) option, the user will retain two of the password keys (i.e xy, xyz) and the secret key. The system will keep two password keys (i.e x, xyz) and store the encrypted digital record. The system will create a folder to store the encrypted digital record. This folder will be indexed (or identified) with metadata (user information) that is signed with a digital signature of that particular digital record made during the encryption phase of the protein-based cryptography method. The user will be prompted to remember the folder index name. Both parties (the user and the system) are required for decryption of the digital record.

When a user needs to decrypt their digital record from the safe deposit encryption service option, they need to establish a VPN to the INES system. The system will prompt the user to provide an index (folder) name. The system will retrieve that folder. The system will then prompt the user to enter their password keys and the system will enter its passwords for that digital record. After the digital record is decrypted the system will upload the decrypted digital record back onto the user's device. The system will erase the data from that session. If necessary, the digital record can be re-encrypted at that time.

If the user picks the full service encryption service option, the users will retain the secret key and index name. The system will retain the password keys. The system will create a folder to store the encrypted digital record. This folder will be indexed (or identified) with metadata (or user information) that is signed with a digital signature of that particular digital record made during the encryption phase of the protein-based cryptography method. The user will be prompted to remember the folder index name. Both parties (the user and system) are still required for decryption of the digital record.

When users need to decrypt the digital record from a full service encryption option, they need to establish a VPN to the system. The system will prompt the user to provide an index (folder) name. The system will retrieve that folder. The system will prompt the user to enter the secret key and the system will enter the password keys for that file. After the system decrypts the digital record, the decrypted digital record will automatically be uploaded to the user's device. The system will erase all data from that session. If necessary, the digital record can be re-encrypted at that time.

All the users have different underlying algorithms protecting their digital records as well as different passwords and secret keys. This makes it far more difficult for a hacker as he would have to break every individual algorithm instead of just one as is used in other encryption services.

### Cryptocurrency

Another example for the above process is for cryptocurrencies using the blockchain. All the individual users wallets have different underlying algorithms protecting their wallets as well as different password and secret keys. This makes it far more difficult for a hacker as he would have to break every individual algorithm instead of just one algorithm and since all of the processing is done in the INES system this system protects against all form of side channel attacks and Trojan Horses on users device.

### Health Care

A specific application for the above process is in the field of personal health care. Users can take their personal medical data with them during every day travel or any activities. When required, users can decrypt personal medical data by logging into an INES system. They can then upload their personal medical data to a doctor or medical facility computer. Using any of the methods describe earlier, standard, safe deposit (split key), and full service depending on the need of users.

### Benefits

The present disclosure provides many benefits. The process takes advantage of biomimicry, which is the design and production of materials, structures, and systems that are modeled on biological entities and processes. As a result, the protein folding cryptography process is decoupled from the lab.

A particular problem is the Rosetta project, which is a project to predict the way in which amino acid chains will fold. This may give hackers the opportunity to use the Rosetta project to determine how the amino acid chains of the present method will fold.

Thus, in a preferred embodiment, the INES system can change the rules of biophysics and thermochemistry of any amino acid (natural or synthetic). These rules inform the system how the amino acids will bend and react to the protein folding cryptography at a given temperature. This information is then used in the process. Because the INES system is changing the way in which the amino acid chains (or protein) fold, the Rosetta project will not help hackers break the encryption.

### EXAMPLES

### Example 1

In one embodiment, a method of encrypting a message includes the steps of:

creating a message in plain text, for example: “Hello World, It is me in Smallville USA”;

converting the plain text message to a DNA sequence cipher text message by way of a random DNA sequence generator to CTAGGTACCTA GAAT ATG;

generating a protein base signature by way of a random amino acid generator, for example, C14H18C1NO—C3H7N1O2S1—C5H10FNO2;

superimposing the mask on the newly encrypted message, wherein the mask and message will look like, for example, C3H7NO2GACTAGGA C13H17NO5 AAGGTAGGC C9H10BrNO2 CTTAAAGGTATGGG AAGGTGA C9H11N1O2; and

obtaining a masked and encrypted message.

As is known in the art, coding for binary 0,1 to C,T, A and G for the DNA sequence is necessary for the transformation stage. The transformation stage is when the plain text message is converted to a DNA sequence cipher text message. For example “hello world” is transformed to CTTAGGA in the beginning prior to the mask being imposed on the DNA sequence cipher text message.

After the encryption phase, the DNA sequence cipher text message has a mask with the primary structure of a protein superimposed thereon. By way of example, the protein is created by building 100 amino acids chains. There are five random amino acid generators that include information about all of the amino acids both natural and synthetic. In this example, the first random amino acid generator will generate 20 amino acids at given temperature. That temperature will be sent to an additional four random amino acid generators, which will generate 20 amino acids chains each, there creating a protein made up of a sequence of 100 amino acids. The key factor of temperature given by the first random amino acid generator generator will determine the way in which the protein is folded along the entire 100 amino acid chain. The process of joining the amino acids into a polypeptide is called dehydration synthesis. After all of the amino acids have been joined together to complete the primary structure of the protein, the primary structure of the protein will be superimposed onto the DNA sequence cipher text message and this phase of encryption provides the x coordinates, which are inputs that are required for decryption.

The secondary structure covers the backbone interactions. The next step is to fold the primary protein structure into alpha helices and beta sheets with hydrogen bonds. This gives a two-dimensional protein structure with x and y coordinates. The tertiary structure will fold the protein structure into a three-dimensional structure with x, y and z coordinates. The quaternary structure will fold the protein into another three-dimensional structure with x, y, and z coordinates. The message is now completely masked and encrypted.

As discussed below, to unlock the mask, the protein needs to be unfolded by using all five inputs (the four structures of the protein—primary, secondary, tertiary, and quaternary, and the temperature).

In one embodiment, a method of decrypting an encrypted message includes the steps of:

a system prompting a user for the conformation of the folded protein;

the user entering the correct primary x, secondary x, y, tertiary x, y, z, quaternary x, y, z, and the temperature at which the protein is folded in Celsius degrees; and

if the conformation is correct, the protein will unfold the message and remove the mask and convert the DNA sequence cipher text message into an ASCII plain text message, thereby allowing the recipient of the message to read the message and to see the amino acid sequence electronic signature for non-repudiation; however, if the conformation is incorrect the message will remain folded.

### Example 2

### Individualized Network Encryption Services for Cryptocurrency and Health Records

In one embodiment, a method of encrypting a digital record includes the steps of:

initiating the creation of a digital record, wherein the digital record is cryptocurrency or a health care record;

sending the digital record to the initiating device;

uploading the digital record to a system capable of encrypting data, wherein the uploading is done by way of a secure VPN tunnel;

scanning the digital record for viruses;

converting the digital record to a DNA sequence cipher digital record message by way of a random DNA sequence generator;

scanning the DNA cipher digital record for viruses;

generating a protein base signature by way of a random amino acid generator;

superimposing a mask on the newly encrypted digital record; and

obtaining a masked and encrypted digital record.

It will be appreciated by those skilled in the art that while protein based cryptography and individualized network encryption services have been described in detail herein, the invention is not necessarily so limited and other examples, embodiments, uses, modifications, and departures from the embodiments, examples, uses, and modifications may be made without departing from the process and all such embodiments are intended to be within the scope and spirit of the appended claims.

What is claimed is:

1. A non-transitory computer-readable medium; storing code, which when executed by one or more uses of a computer system, causes the system to implement a method of encrypting a digital record comprising the steps of:
uploading a digital record to a system, wherein the system encrypts the digital record and wherein the uploading is done by way of a secure VPN tunnel;
scanning the digital record for viruses;
converting the digital record into a DNA sequence cipher digital record;
scanning the DNA cipher digital record for viruses;
using an amino acid generator to generate a sequence of random amino acids to create an amino acid sequence electronic signature, wherein the amino acid sequence electronic signature will be merged with the DNA sequence cipher digital record;
using an amino acid generator to generate a sequence of random amino acids to create an amino acid sequence data mask;
superimposing the amino acid sequence data mask onto the DNA sequence cipher digital record and amino acid sequence electronic signature, thereby creating a masked marker;
using a random temperature generator to generate a random temperature that will be passed to a primary protein structure generator;
creating a primary protein structure using N number of amino acids generator to generate N number of random sequences of amino acids, wherein the primary protein structure of the N number of amino acid sequences is dependent on the temperature value sent from the random temperature generator;
merging the masked marker comprised of the amino acid sequence data mask, the DNA sequence cipher digital record, and the amino acid sequence electronic signature onto a primary protein structure of the N number of amino acid sequences; and
folding of the primary protein structure into secondary, tertiary, and quaternary protein structures at the temperature value generated by the random temperature generator; and
obtaining a masked and encrypted digital record.

2. The method of claim 1, wherein the amino acids are natural or synthetic or a combination thereof and wherein the random temperature generator determines the way in which the protein folds.

3. The method of claim 2, wherein the DNA sequence cipher digital record is the same size as the amino acid sequence electronic signature.

4. The method of claim 2, wherein the DNA sequence cipher digital record is the same size as the amino acid sequence data mask.

5. The method of claim 2, wherein the DNA sequence cipher digital record is the same size as the N number of amino acid sequences.

6. The method of claim 1, wherein N=5.

7. The method of claim 1, wherein the number of amino acids in each N number of amino acid sequences is 20.

8. The method of claim 1, wherein the number of amino acids in the amino acid sequence of the protein is 100.

9. A method of encrypting and masking a digital record comprising the steps of:
creating a digital record;
uploading the digital record to a system, wherein the system encrypts the digital record and wherein the uploading is done by way of a secure VPN tunnel;
scanning the digital record for viruses;
converting the digital record to a cipher digital record;
adding an electronic signature to the cipher digital record, wherein the electronic signature is created by a random mask generator;
constructing a mask to superimpose onto the cipher digital record, wherein the mask is created by a random electronic signature generator;
superimposing the mask onto the cipher digital record, thereby creating a marked marker;
obtaining a temperature from a random temperature generator;
obtaining a sequence of amino acids from an amino acid generator; and
passing the temperature and the amino acid sequence to the marked marker and constructing a primary protein structure of the amino acid sequence, thereby creating a linear protein structure.

10. The method of claim 9, wherein the cipher digital record is a DNA sequence cipher digital record.

11. The method of claim 9, wherein the method further includes the step of scanning the DNA sequence cipher digital record prior to adding the electronic signature.

12. The method of claim 9, wherein the method further includes the step of passing the temperature to a secondary structure and constructing a secondary structure from the linear protein structure; wherein the secondary structure is folded into a coil or loop helix and beta sheet and is two dimensional.

13. The method of claim 12, wherein the method further includes the step of passing the temperature to a tertiary structure and constructing the tertiary structure from the secondary structure, wherein the tertiary structure is made from disulfide bonds and is three dimensional.

14. The method of claim 13, wherein the method further includes the step of constructing a quaternary structure from the tertiary structure, wherein the quaternary structure further folds the tertiary structure into a three dimensional structure; and obtaining a masked and encrypted message.

15. A method of encrypting a digital record includes the steps of:
initiating the creation of a digital record, wherein the digital record is cryptocurrency or a health care record;
sending the digital record to the initiating device;
uploading the digital record from the initiating device to a system for encrypting data, wherein the uploading is done by way of a secure VPN tunnel;
scanning the digital record for viruses;
converting the digital record to a DNA sequence cipher digital record by way of a random DNA sequence generator;
scanning the DNA cipher digital record for viruses;
generating a protein base signature by way of a random amino acid generator;
superimposing a mask on the newly encrypted digital record; and
obtaining a masked and encrypted digital record.
